(19) United States
(12) Patent Application Publication
(10) Pub. No.: US 2010/0269538 A1
(43) Pub. Date: Oct. 28, 2010

(54) OIL SEPARATOR AND COMPRESSOR FOR REGENERATIVE REFRIGERATOR

(75) Inventors: TSUTOMU SUZUKI, Tokyo (JP); Toru Maruyama, Tokyo (JP)

Correspondence Address: IPUSA, P.L.L.C, 1054 31ST STREET, N.W., Suite 400, Washington, DC, 20007, US

(73) Assignee: SUMITOMO HEAVY INDUSTRIES, LTD

(21) Appl. No.: 12/706,113

(22) Filed: Feb. 16, 2010

(30) Foreign Application Priority Data
Apr. 23, 2009 (JP) 2009-105658

(51) Int. Cl. F25B 43/02; B01D 35/02

(52) U.S. Cl. 62/470; 210/359

(57) ABSTRACT

An oil separator, includes a first cylindrical-shaped punching plate having a plurality of first piercing holes; a second cylindrical-shaped punching plate having a plurality of second piercing holes, the second cylindrical-shaped punching plate being situated inside the first cylindrical-shaped punching plate; a filter member received between the first cylindrical-shaped punching plate and the second cylindrical-shaped punching plate, the filter member being configured to eliminate oil contained in a coolant gas; a filter element where the coolant gas moves from the second cylindrical-shaped punching plate to the first cylindrical-shaped punching plate; and a part configured to control leaking oil leaking from the first piercing holes of the first cylindrical-shaped punching plate so that the leaking oil flows on a surface of the first cylindrical-shaped punching plate excluding positions of the first piercing holes.

### CROSS-REFERENCE TO RELATED APPLICATIONS

This patent application is based upon and claims the benefit of priority of Japanese Patent Application No. 2009-105658 filed on Apr. 23, 2009, the entire contents of which are incorporated herein by reference.

### BACKGROUND OF THE INVENTION

1. Field of the Invention

The present invention generally relates to oil separators and a compressor for a regenerative refrigerator. More specifically, the present invention relates to an oil separator and a compressor for a regenerative refrigerator having a filter element for collecting oil contained in coolant gas.

2. Description of the Related Art

In general, there are various kinds of regenerative refrigerators such as a GM (Gifford-McMahon) cryogenic refrigerator, a Joule-Thomson type+GM cryogenic refrigerator, a Claude cycle refrigerator, or a Stirling cryogenic refrigerator. Among them, generally, the GM cryogenic refrigerators have been widely used. The GM cryogenic refrigerator is connected to a compressor for a regenerative refrigerator (hereinafter “compressor”). Coolant gas, generally helium gas, supplied from the compressor and having a high pressure is adiabatically expanded from the high pressure to a low pressure in the cryogenic refrigerator. A cryogenic cooling process is performed by using the cryogenic cooling effect generated by the adiabatic expansion.

In the compressor, coolant gas (return gas) having a low pressure which is returned from the GM cryogenic refrigerator is compressed (pressurized) by a compressor main body. The pressurized coolant gas is resupplied to the GM cryogenic refrigerator as supply gas. The return gas returned from the GM cryogenic refrigerator is recompressed (re-pressurized) by the compressor main body. A cooling process is applied to the pressurized coolant gas (supply gas) at a coolant gas heat exchanging part.

The coolant gas where the cooling process has been applied is transferred to an oil separator so that oil separation is performed. See Japanese Laid Open Patent Application Publication No. 2003-062417, Japanese Laid Open Patent Application Publication No. 8-233415, Japanese Laid Open Patent Application Publication No. 7-328364. The coolant gas where gas-liquid separation has been performed is transferred to an adsorber and then supplied to the GM cryogenic refrigerator as supply gas.

The oil separator has a structure where an oil separation element is provided in a cell. In addition, the oil separator includes two pipe-shaped punching plates having different diameters and a filter member configured to remove oil contained in the coolant gas.

Large numbers of piercing holes (punch holes) are formed in each of the punching plates situated inside and outside the oil separator. The coolant gas passes through the piercing holes. The coolant gas enters the filter member via the piercing holes formed in the punching plate situated inside the oil separator so that the oil is separated by the filter member. After that, the coolant gas is discharged to the outside of the oil separator from the piercing holes formed in the punching plate situated outside the oil separator. Therefore, the oil contained in the coolant gas is removed by the filter member.

However, in a related art oil separator, oil leaking out from the piercing holes formed in the punching plate situated outside the oil separator is remixed with the coolant gas where the oil is separated by the filter member. Hence, it is not possible to securely perform the oil separation. Details of this phenomenon are discussed below with reference to FIG. 1.

FIG. 1 is a view for explaining problems generated in a related art oil separator. More specifically, FIG. 1(A) is an expanded cross-sectional view showing a vicinity of a piercing hole 136 of an oil separation element 130. In FIG. 1(A), a left side shows an inside of the oil separator and a right side shows an outside of the oil separator. As discussed above, the coolant gas enters a filter member 132 from a punching plate situated inside the oil separator (not illustrated). After the oil is removed from the coolant gas by the filter member 132, the coolant gas passes through the piercing hole 136 of the punching plate 134 so as to be discharged outside the oil separation element 130.

In a case where, for example, a large amount of the oil is contained in the coolant gas, all of the oil cannot be held by the filter member 132, so that a part of the oil may leak out from the piercing hole 136 to a surface 137 of the punching plate 134. In the following description, the oil leaking from the piercing hole 136 is called leaking oil 140.

An arrow indicated by a solid line in FIG. 1(A) indicates a flow of the leaking oil 140. As shown in FIG. 1(A) and FIG. 1(B), the leaking oil 140 which leaks out from the piercing hole 136 moves on the surface 137 of the punching plate 134 in a downward direction due to gravity.

In the related art, when a diameter of the piercing holes 136 formed in the punching plate 134 and a pitch between neighboring piercing holes 136 are determined, leakage of the leaking oil 140 is not considered. Because of this, the leaking oil leaking from a piercing hole 136a shown in FIG. 1(B) may easily enter a piercing hole 136b positioned below the piercing hole 136a.

When the leaking oil 140 flows into the piercing hole 136b, as shown in FIG. 1(C), the leaking oil 140 forms an oil film so as to close the piercing hole 136b. As discussed above, the coolant flows out from the inside to the outside in the piercing holes 136. Accordingly, if the oil film of the leaking oil 140 is formed at the piercing hole 136b, the oil film of the leaking oil 140 is broken by the coolant gas. As a result of this, the oil film of the leaking oil 140 scatters due to the coolant gas as shown in FIG. 1(D). This phenomenon is called bubbling.

Thus, if the oil film of the leaking oil 140 is broken and scatters because of the flow of the coolant gas, the leaking oil 140 is remixed with the coolant gas after the oil is removed by the filter member 132. Accordingly, it is not possible to remove the oil by the related art oil separator with high efficiency.

### SUMMARY OF THE INVENTION

Accordingly, embodiments of the present invention may provide a novel and useful oil separator and compressor for a regenerative refrigerator, solving one or more of the problems discussed above.

More specifically, the embodiments of the present invention may provide an oil separator and compressor for a regenerative refrigerator whereby oil can be securely removed from coolant gas.

Another aspect of the embodiments of the present invention may be to provide an oil separator, including a first cylindrical-shaped punching plate having a plurality of first piercing holes; a second cylindrical-shaped punching plate having a plurality of second piercing holes, the second cylindrical-shaped punching plate being situated inside the first cylindrical-shaped punching plate; a filter member received between the first cylindrical-shaped punching plate and the second cylindrical-shaped punching plate, the filter member being configured to eliminate oil contained in a coolant gas; a filter element where the coolant gas moves from the second cylindrical-shaped punching plate to the first cylindrical-shaped punching plate; and a part configured to control leaking oil leaking from the first piercing holes of the first cylindrical-shaped punching plate so that the leaking oil flows on a surface of the first cylindrical-shaped punching plate excluding positions of the first piercing holes.

Another aspect of the embodiments of the present invention may be to provide a compressor for a regenerative refrigerator, the compressor being configured to supply coolant gas to the regenerative refrigerator, the compressor including: an oil separator including a first cylindrical-shaped punching plate having a plurality of first piercing holes; a second cylindrical-shaped punching plate having a plurality of second piercing holes, the second cylindrical-shaped punching plate being situated inside the first cylindrical-shaped punching plate; a filter member received between the first cylindrical-shaped punching plate and the second cylindrical-shaped punching plate, the filter member being configured to eliminate oil contained in the coolant gas; a filter element where the coolant gas moves from the second cylindrical-shaped punching plate to the first cylindrical-shaped punching plate; and a part configured to control leaking oil leaking from the first piercing holes of the first cylindrical-shaped punching plate so that the leaking oil flows on a surface of the first cylindrical-shaped punching plate excluding positions of the first piercing holes.

According to the oil separator of embodiments of the present invention, it is possible to prevent that the leaking oil leaking out from the first piercing hole flows in another first piercing hole so that an oil film is formed. Hence, it is possible to prevent the leaking oil from scattering and from being remixed with the coolant gas after the oil is separated by the oil separator.

Additional objects and advantages of the embodiments are set forth in part in the description which follows, and in part will become obvious from the description, or may be learned by practice of the invention. The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a view for explaining problems generated in a related art oil separator;

FIG. 2 is a view showing a structure of a compressor of a first embodiment of the present invention;

FIG. 3 is a partial cross sectional view showing an oil separator of the first embodiment of the present invention;

FIG. 4 is a plan view and a partial cross-sectional view showing an oil separation element of the oil separator shown in FIG. 3;

FIG. 5 is an expanded view of piercing holes formed in a punching plate;

FIG. 6 is a view for explaining flow of leaking oil at the oil separator of the first embodiment of the present invention;

FIG. 7A is a table showing experimental results of a surface state of a punching plate, an oil discharged amount, gas flow resistance, glass wool projection, and a size of an oil path when a diameter of a piercing hole, a pitch of the piercing holes, and a ratio of a hole area are changed;

FIG. 7B is a table showing determination conditions of the surface state and the oil discharged amount;

FIG. 8 is an expanded view of piercing holes formed in a punching plate of a second embodiment of the present invention;

FIG. 9 is an expanded view of piercing holes formed in a punching plate of a third embodiment of the present invention;

FIG. 10 is an expanded view of piercing holes formed in a punching plate of a fourth embodiment of the present invention;

FIG. 11 is an expanded view of piercing holes formed in a punching plate of a fifth embodiment of the present invention; and

FIG. 12 is an expanded view of piercing holes formed in a punching plate of a sixth embodiment of the present invention.

### DETAILED DESCRIPTION OF THE PREFERRED EMBODIMENTS

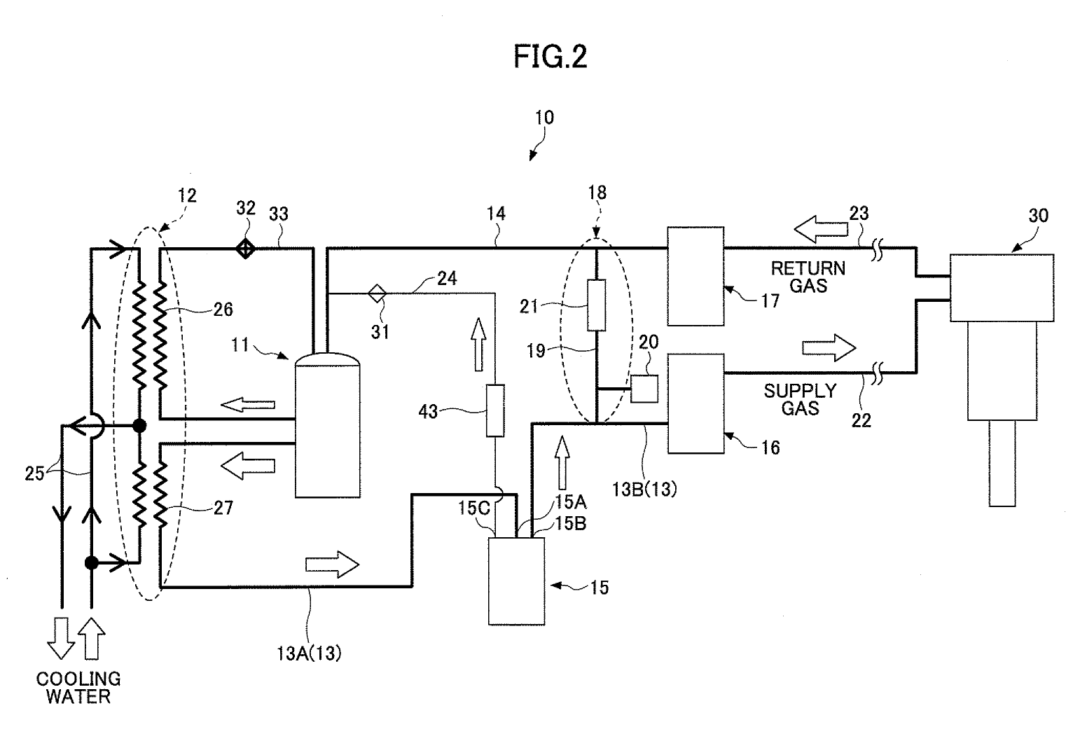

A description is given below, with reference to the FIG. 2 through FIG. 12 of embodiments of the present invention.

FIG. 2 is a view showing a structure of a compressor 10 for a regenerative refrigerator (hereinafter “compressor 10”) of a first embodiment of the present invention. The compressor 10 is connected to a GM (Gifford-McMahon) cryogenic refrigerator 30 by a supply pipe 22 and a return pipe 23.

In the compressor 10, coolant gas (return gas) having a low pressure which is returned from the GM cryogenic refrigerator 30 via the return pipe 23 is compressed (pressurized) by a compressor main body 11. The pressurized coolant gas, as supply gas, is resupplied to the GM cryogenic refrigerator 30 via the supply pipe 22. The compressor 10 includes the compressor main body 11, a heat exchanger 12, a high pressure side pipe 13, a low pressure side pipe 14, an oil separator 15, an adsorber 16, a storage tank 17, a bypass mechanism 18, and other parts.

The return gas returned from the GM cryogenic refrigerator 30 flows into the storage tank 17 via the return pipe 23 first. The storage tank 17 eliminates pulsations contained in the return gas.

The return gas where the pulsations are eliminated by the storage tank 17 is led out to the low pressure side pipe 14. The low pressure side pipe 14 is connected to the compressor main body 11. Therefore, the return gas where the pulsations are eliminated by the storage tank 17 is supplied to the compressor main body 11.

The compressor main body 11 is, for example, a scroll type or a rotary type pump. The compressor main body 11 is configured to compress (pressurize) the return gas. The coolant gas compressed (pressurized) by the compressor main body 11 is called supply gas. The compressor main body 11 sends the compressed (pressurized) supply gas to the high pressure side pipe 13A. When the supply gas is compressed (pressurized) by the compressor main body 11, the supply gas is sent out to the high pressure side pipe 13A in a mixed state where a slight amount of oil in the compressor main body 11 is mixed with the supply gas.

The compressor main body 11 is cooled by the oil. Because of this, an oil cooling pipe 33 configured to circulate the oil is connected to an oil heat exchanging part 26 forming part of the heat exchanger 12. In addition, an orifice 32 is provided at the oil cooling pipe 33. The orifice 32 is configured to control a flow amount of the oil flowing inside the oil cooling pipe 33.

The heat exchanger 12 includes the oil heat exchanging part 26 and a coolant gas heat exchanging part 27. In the oil heat exchanging part 26, cooling water circulates in a cooling water pipe 25 so that a cooling process is applied to the oil flowing in the oil cooling pipe 33. The coolant gas heat exchanging part 27 is configured to cool the supply gas. Heat is transferred from the oil flowing in the oil cooling pipe 33 at the oil heat exchanging part 26 so that the oil flowing in the oil cooling pipe 33 is cooled. In addition, heat is transferred from the supply gas flowing in the high pressure side pipe 13A at the coolant gas heat exchanging part 27 so that the supply gas flowing in the high pressure side pipe 13A is cooled.

The supply gas compressed (pressurized) at the compressor main body 11 and cooled by the coolant gas heat exchanging part 27 is supplied to the oil separator 15 via the high pressure side pipe 13A. In the oil separator 15, the oil contained in the supply gas is separated from the supply gas and impurities and dust contained in the gas are eliminated. For the convenience of explanation, details of the structure of the oil separator 15 are discussed below.

The supply gas where the oil is eliminated by the oil separator 15 is transferred to the adsorber 16 via the high pressure side pipe 13B. The adsorber 16 eliminates vaporized oil components contained in the supply gas. When the vaporized oil components are eliminated at the adsorber 16, the supply gas is led out to the supply pipe 22 so as to be supplied to the GM cryogenic refrigerator 30.

The bypass mechanism 18 includes a bypass pipe 19, a high pressure side pressure detecting device 20, and a bypass valve 21. The bypass pipe 19 connects a high pressure side of the compressor 10 and a low pressure side of the compressor 10 to each other. The supply gas flows at the high pressure side and the return gas flows at the low pressure side. The high pressure side pressure detecting device 20 is configured to detect the pressure of the supply gas in the high pressure side pipe 13A. The bypass valve 21 is an electrically operated valve device configured to open and close the bypass pipe 19. In addition, while the bypass valve 21 is normally closed, the bypass valve 21 is driven and controlled by the high pressure side pressure detecting device 20.

More specifically, when the high pressure side pressure detecting device 20 detects that a pressure in the high pressure side pipe 13A, namely a pressure of the supply gas from the compressor main body 11 to the oil separator 15, becomes equal to or greater than a predetermined pressure, the bypass valve 21 is driven by the high pressure side pressure detecting device 20 so as to be opened. Thus, it is possible to prevent the supply gas having a pressure equal to or greater than the predetermined pressure from being supplied to the GM cryogenic refrigerator 30.

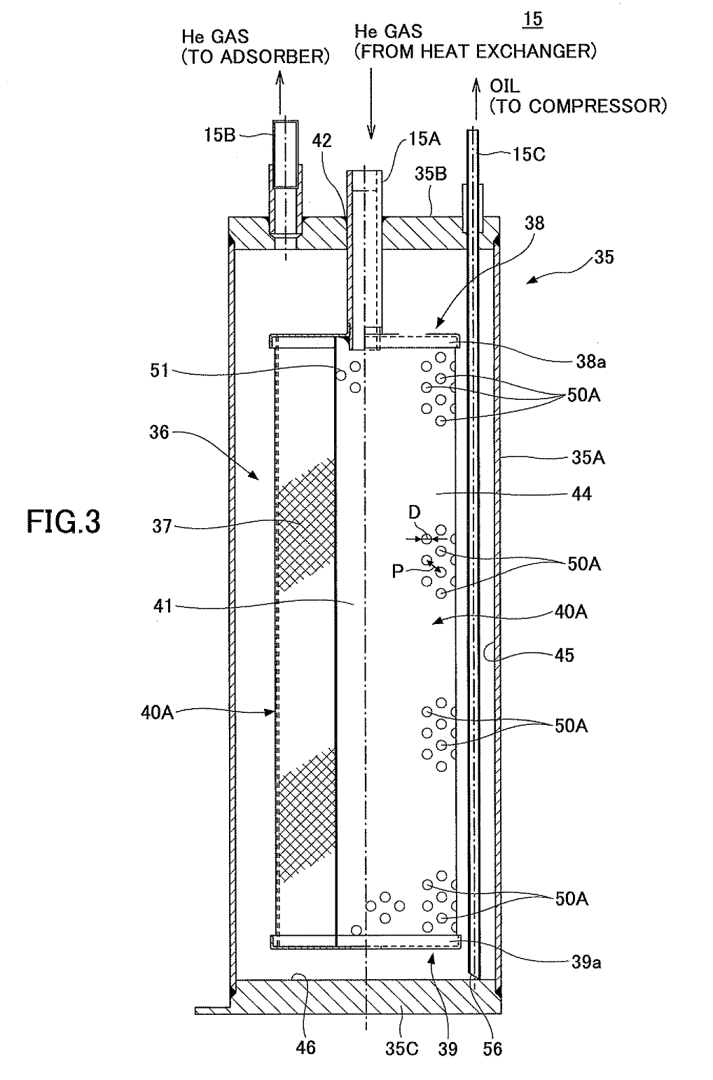

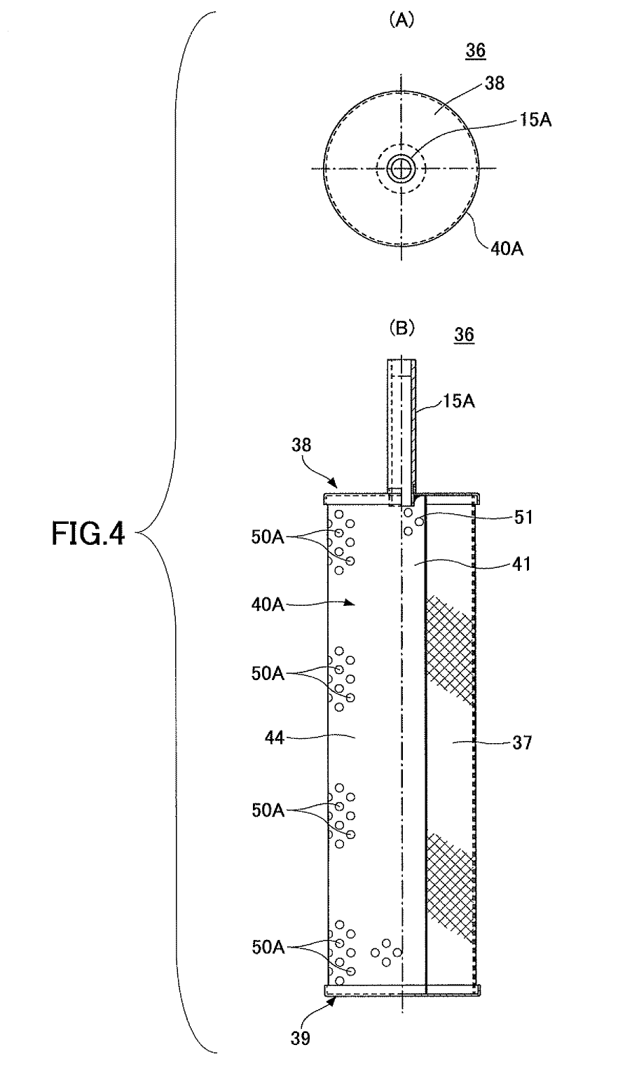

Next, the details of the oil separator 15 are discussed. FIG. 3 and FIG. 4 are cross-sectional views of the oil separator 15 of the first embodiment of the present invention. The oil separator 15 includes a shell 35 and a filter element 36. In FIG. 3, a left half portion relative to a center line of the filter element 36 is illustrated as a cross-sectional view. In FIG. 4, a right half portion relative to the center line of the filter element 36 is illustrated as a cross-sectional view.

The shell 35 includes a cylinder part 35A, an upper part flange 35B, and a lower part flange 35C. The cylinder part 35A has a hollow cylindrical-shaped configuration. The lower flange part 35C is fixed to a lower end part of the cylinder part 35A by welding. The upper flange 35B is fixed to an upper end part of the cylinder part 35A by welding. Thus, the shell 35 is closed in an airtight manner.

A high pressure gas leading-in pipe 15A, a high pressure gas leading-out pipe 15B, and an oil returning pipe 15C are provided at the upper flange 35B. The high pressure gas leading-in pipe 15A is connected to the high pressure side pipe 13A and therefore the supply gas pressurized by the compressor main body 11 is led into the oil separator 15.

The high pressure gas leading-out pipe 15B is connected to the high pressure side pipe 13B. The high pressure side pipe 13B connects the oil separator 15 and the adsorber 16. In addition, an oil returning port is connected to an upper end part of the oil returning pipe 15C. Furthermore, a leading-in opening 56 is provided at the lower end part of the oil returning pipe 15C. The leading-in opening 56 is opened in the vicinity of a bottom part of the oil separator 15.

The oil returning port of the oil returning pipe 15C is connected to an oil returning pipe 24 (see FIG. 2). A high pressure side of the oil returning pipe 24 is connected to the oil separator 15 via the oil returning pipe 15C. A low pressure side of the oil returning pipe 24 is connected to the low pressure side pipe 14. Furthermore, a filter 43 and an orifice 31 are provided on the way of the oil returning pipe 24. The filter 43 is configured to eliminate dust contained in the oil separated by the oil separator 15. The orifice 31 is configured to control a returning amount of the oil.

The filter element 36 includes the high pressure leading-in pipe 15A, a filter member 37, an upper part cover 38, a lower part cover 39, and punching plates 40A and 41.

In the filter member 37, glass wool is wound at a core including the punching plate 41, and the punching plate 40A is provided at an outermost circumferential part. The upper part cover 38 is fixed to the upper end part of the filter member 37 by using an adhesive (not illustrated). The lower part cover 39 is fixed to the lower end part of the filter member 37 by using an adhesive (not illustrated). Under this structure, the filter member 37, the upper part cover 38, the lower part cover 39, and the punching plates 40A and 41 are formed in a body. The filter member 37 is fixed to the high pressure gas leading-in pipe 15A by welding the upper part cover 38 to the high pressure gas leading-in pipe 15A.

The punching plate (first punching plate) 40A provided outside the filter member 37 and the punching plate (second punching plate) 41 provided inside the filter member 37 have cylindrical-shaped configurations. In addition, piercing holes 50A are formed in the punching plate 40A and piercing holes 51 are formed in the punching plate 41. In this embodiment, the piercing holes 50A and 51 have circular-shaped configurations. The supply gas (coolant gas) led in from the high pressure gas leading-in pipe 15A is led in the filter member 37 via the piercing holes 51 formed in the punching plate 41.

When the supply gas moves in the filter member 37, the oil contained in the supply gas is eliminated from the supply gas by the filter member 37. In addition, the supply gas from which the oil has been eliminated by the filter member 37 passes through the piercing holes 50A of the punching plate 40A so as to be discharged outside the filter member 37 (in the shell 35).

Here, details of the punching plate 40A are discussed. FIG. 5 is an expanded view of the piercing holes 50A formed in the punching plate 40A. In the following explanation, a lower part is illustrated in a gravity direction and an upper part is illustrated in a direction opposite to the gravity direction.

As discussed above, when the supply gas moves in the filter member 37 from the punching plate 41 to the punching plate 40A, the oil contained in the supply gas is eliminated (removed) by the filter member 37. In a case where, for example, a large amount of the oil is contained in the supply gas, the filter member 37 cannot hold all of the oil. Hence, a part of the oil may leak out from the piercing holes 50A to a surface 44 of the punching plate 40A. The oil leaking out from the piercing holes 50A is called leaking oil 60.

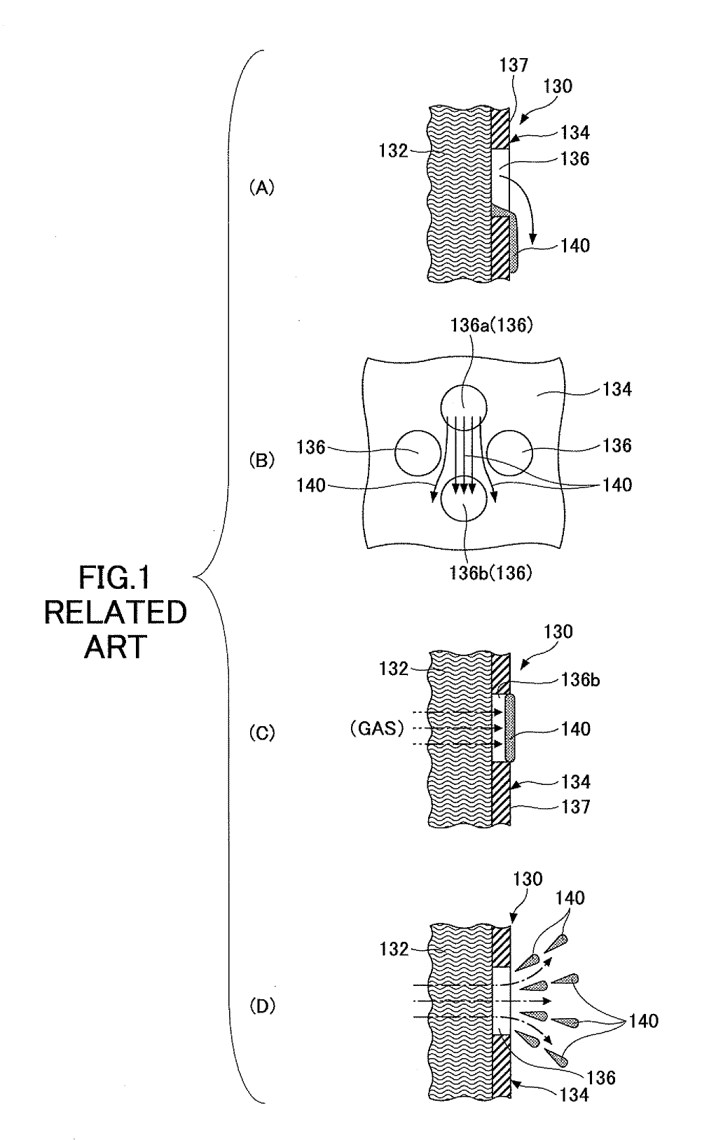

In a case where the leaking oil 60 flows into other piercing holes 50A so that bubbling is generated, as discussed above with reference to FIG. 1, the leaking oil 60 may be remixed with the supply gas from which the oil has been eliminated by the filter member 37. In the embodiment of the present invention, a part configured to control the flow of the leaking oil 60 is provided so that the leaking oil 60 leaking out from the piercing holes 50A of the punching plate 40A flows on a portion of the surface 44 of the punching plate 40A excluding positions of the piercing holes 50A.

In this embodiment of the present invention, the part configured to control the flow of the leaking oil 60 is realized by optimizing a diameter D of the piercing holes 50A, a pitch P of neighboring piercing holes 50A, a ratio (R_{OP}) of a hole area of the piercing holes 50A at the surface 44 of the punching plate 40A, and other parts. More specifically, in the embodiment of the present invention, the diameter D of the piercing holes 50A is set to be equal to or greater than 4 mm and equal to or less than 10 mm (4 mm≦D≦10 mm). The pitch P of neighboring piercing holes 50A is set to be equal to or greater than 6 mm and equal to or less than 15 mm (6 mm≦P≦15 mm). The ratio (R_{OP}) of a hole area of the piercing holes 50A at the surface 44 of the punching plate 40A to the area of the surface 44 is set to be equal to or greater than 40% and equal to or less than 63% (40%≦R_{OP}≦63%).

Thus, by optimizing the diameter D of the piercing holes 50A, the pitch P of neighboring piercing holes 50A, and the ratio (R_{OP}) of a hole area of the piercing holes 50A, the leaking oil 60 flows on only the surface 44 of the punching plate 40A such that the leaking oil 60 is prevented from flowing into other piercing holes 50A. Here, other piercing holes 50A means piercing holes different from the piercing hole from which the leaking oil 60 leaks.

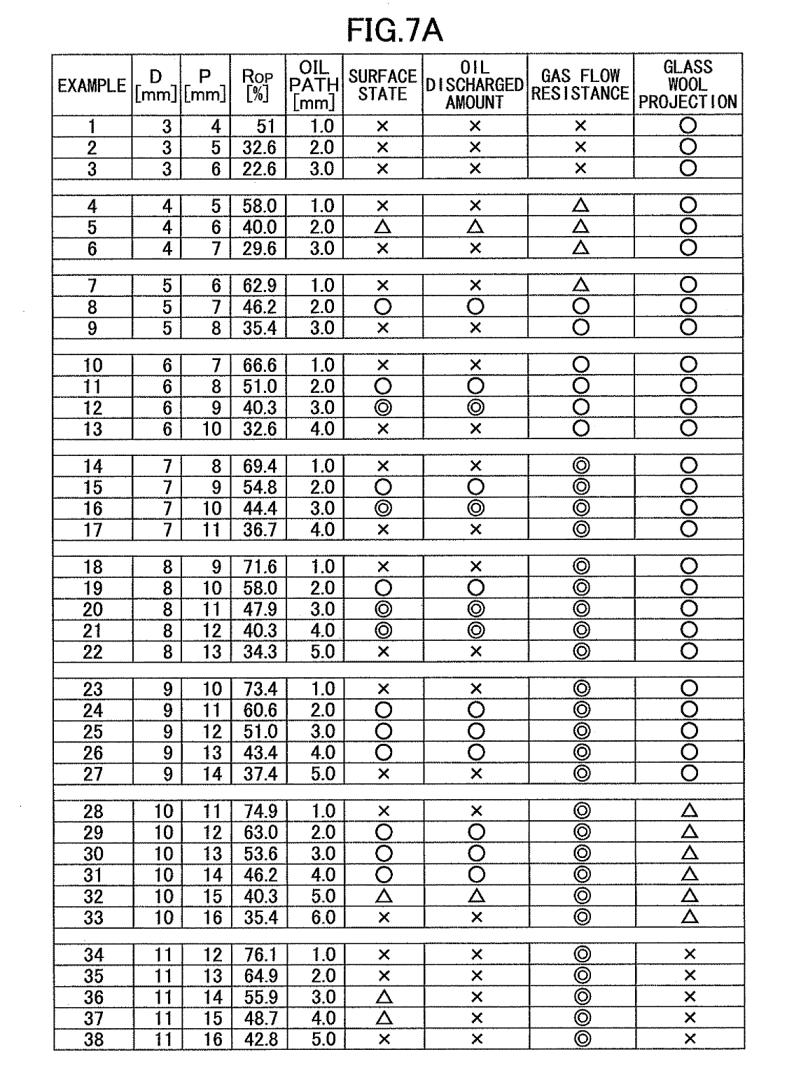

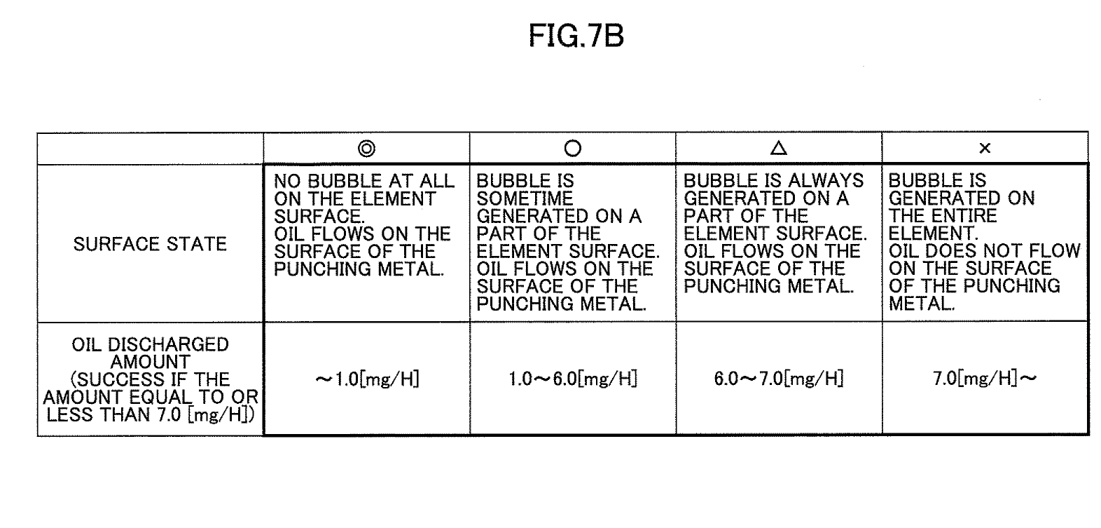

Next, the reason why the diameter D of the piercing holes 50A, the pitch P of neighboring piercing holes 50A, and the ratio (R_{OP}) of a hole area of the piercing holes 50A are set as described above is discussed with reference to FIG. 7A and FIG. 7B.

FIG. 7A is a table showing experimental results of a surface state of the surface 44 of the punching plate 40, an oil discharged amount, gas flow resistance, glass wool projection, and a size of an oil path when the diameter D of the piercing hole 50A, the pitch P of neighboring piercing holes 50A, and the ratio (R_{OP}) of a hole area of the piercing holes 50A are changed. In FIG. 7A, evaluations of the experimental results are indicated as “⊚”, “◯”, “Δ”, and “X”. In this embodiment, determinations other than “X”, namely “⊚”, “◯”, and “Δ” are regarded to mean that effects are achieved.

FIG. 7B is a table showing determination conditions of the surface state and the oil discharged amount. The results of the determinations shown in FIG. 7A, namely, “⊚”, “◯”, “Δ”, and “X” are made based on conditions for determination shown in FIG. 7B. Here, “oil discharged amount” shown in FIG. 7A means the amount of oil not eliminated (collected) by the oil separation element 36, that is, the amount of oil discharged from the high pressure side leading-out pipe 15B. In addition, “oil path” shown in FIG. 7A means a width of a flow path where the leaking oil 60 flows, the flow path being formed in the surface 44 of the punching plate 40A.

Furthermore, “gas flow resistance” shown in FIG. 7A means flow resistance of the supply gas flowing in the oil separation element 36. In a case where the gas flow resistance is large, the supply gas does not properly pass through the oil separation element 36 so that efficiency of elimination of the oil may be degraded. In the section of “gas flow resistance” in FIG. 7A, “X” means poor; “Δ” means pass; “◯” means good; and “⊚” means excellent.

In the meantime, “glass wool projection” shown in FIG. 7A indicates whether the glass wool forming the filter member 37 projects from the piercing holes 50A formed in the punching plate 40A. In a case where the diameter D of the piercing holes 50A is large, the glass wool may project from the piercing holes 50A. When the glass wool projects from the piercing holes 50A, it may not be possible to properly eliminate the oil contained in the supply gas and the leaking amount of the leaking oil 60 may be increased.

Accordingly, it is preferable that the glass wool forming the filter member 37 does not project from the piercing holes 50A. In the section of “glass wool projection” in FIG. 7A, “X” means that the glass wool projects from the piercing holes 50A; “Δ” means there is no problem while projection is partially found; “◯” means there is no problem while projection is slightly partially found; and “⊚” means there is no projection of the glass wool at all.

As shown in FIG. 7A, the gas flow resistance is influenced by the diameter D of the piercing holes 50A and the pitch P of the neighboring piercing holes 50A. As shown in experimental examples 1 through 3 of FIG. 7A, in a case where the diameter D of the piercing holes 50A is equal to or less than 3 mm, the gas flow resistance is large and the supply gas does not properly pass through the oil separation element 36. On the other hand, as shown in experimental examples 4 through 38 of FIG. 7A, in a case where the diameter D of the piercing holes 50A is greater than 3 mm, it is found that the supply gas properly passes through the oil separation element 36.

The glass wool projection is influenced by the diameter D of the piercing holes 50A. As shown in experimental examples 34 through 38 of FIG. 7A, it is found that the glass wool projects from the piercing holes 50A when the diameter D of the piercing holes 50A is greater than 11 mm. Accordingly, in order to effectively prevent leakage of the leaking oil 60, it is necessary to make the piercing holes 50A have a diameter D equal to or less than 10 mm. Through the results of experiments pertaining to the gas flow resistance and the glass wool projection, it is found that the diameter D of the piercing holes 50A should be equal to or greater than 4 mm and equal to or less than 10 mm (4 mm≦D≦10 mm).

Next, the oil discharged amount and the surface state are discussed. An effect where the leaking oil 60 is prevented from being mixed with the supply gas is achieved in the experimental examples 5, 8, 11, 12, 15, 16, 19 through 21, 24, 25, 26, and 29 through 32 among the experimental examples shown in FIG. 7A. These experimental examples may be called effective experimental examples as a general term.

In the effective experimental examples, a minimum value of the pitch P is 6 mm as shown in the experimental example 5. A maximum value of the pitch P is 15 mm as shown in the experimental example 32. Accordingly, it is found that the pitch P of neighboring piercing holes 50A should be equal to or greater than 6 mm and equal to or less than 15 mm (6 mm≦P≦15 mm), in order to prevent mixture of the leaking oil 60 with the supply gas.

In the effective experimental examples, a minimum value of the ratio (R_{OP}) of the hole area of the piercing holes 50A at the surface 44 of the punching plate 40A is 40.0% as shown in the experimental example 5. A maximum value of the ratio (R_{OP}) of the hole area of the piercing holes 50A at the surface 44 of the punching plate 40A is 63.0% as shown in the experimental example 29. Accordingly, it is found that the ratio (R_{OP}) of the hole area of the piercing holes 50A at the surface 44 of the punching plate 40A should be equal to or greater than 40% and equal to or less than 63% (40%≦R_{OP}≦63%), in order to prevent mixture of the leaking oil 60 with the supply gas.

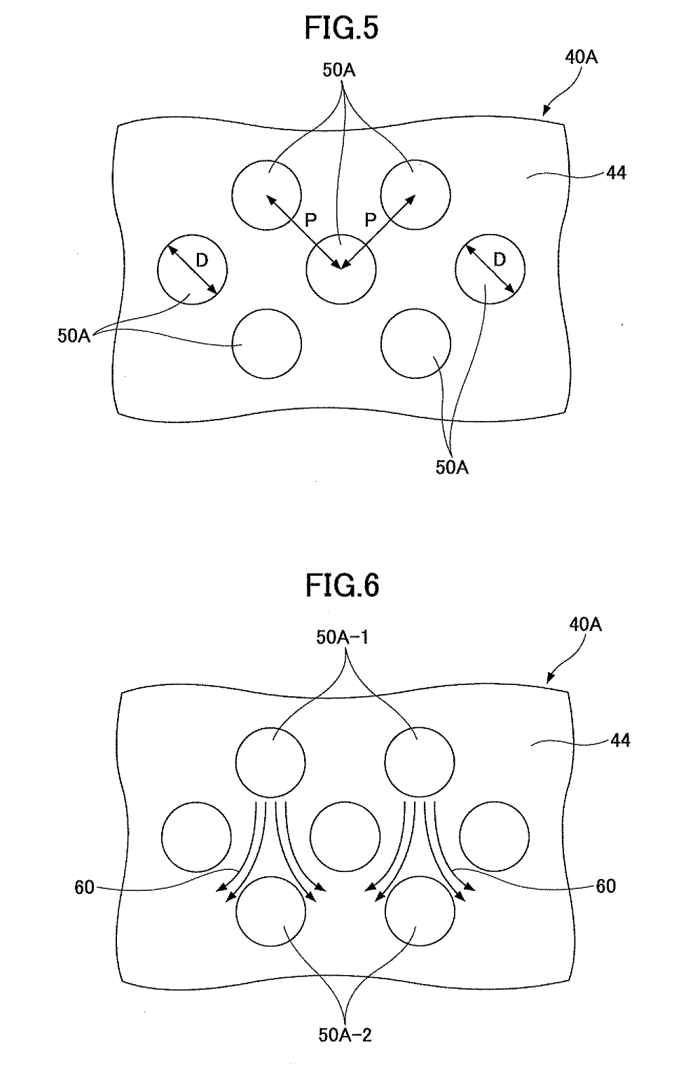

Thus, by setting the diameter D of the piercing holes 50A to be equal to or greater than 4 mm and equal to or less than 10 mm (4 mm≦D≦10 mm), by setting the pitch P of neighboring piercing holes 50A to be equal to or greater than 6 mm and equal to or less than 15 mm (6 mm≦P≦15 mm), and by setting the ratio (R_{OP}) of the hole area of the piercing holes 50A at the surface 44 of the punching plate 40A to be equal to or greater than 40% and equal to or less than 63% (40%≦R_{OP}≦63%), the following effect can be achieved. That is, even if the leaking oil 60 leaks from the piercing holes 50A-1, the flow of the leaking oil 60 can be controlled so that the leaking oil 60 flows on only the surface of the punching plate 40A as shown in FIG. 6 and does not flow in other piercing holes 50A-2. Accordingly, by setting the diameter D of the piercing holes 50A, the pitch P of neighboring piercing holes 50A, and the ratio (R_{OP}) of the hole area of the piercing holes 50A at the surface 44 of the punching plate 40A as discussed above, it is possible to prevent the leaking oil 60 from being mixed with the supply gas so that reliability of the oil separation element 36 can be improved. In FIG. 6, arrows indicated by solid lines show flow directions of the leaking oil 60.

Similarly, in the effective experimental examples, a minimum value of the width of the oil path is 2.0 mm as shown in the experimental examples 5, 8, 11, 19, 24, and 29. A maximum value of the width of the oil path is 5.0 mm as shown in the experimental example 32. Accordingly, it is found that the width W of the oil path should be equal to or greater than 2.0 mm and equal to or less than 5.0 mm (2.0 mm≦W≦5.0 mm), in order to prevent mixture of the leaking oil 60 with the supply gas. If the width W of the oil path is set to be equal to or greater than 2.0 mm and equal to or less than 5.0 mm (2.0 mm≦W≦5.0 mm) in addition to the above-discussed conditions, it is possible to prevent the leaking oil 60 from being mixed with the supply gas so that reliability of the oil separation element 36 can be improved.

Next, second through fourth embodiments of the present invention are discussed.

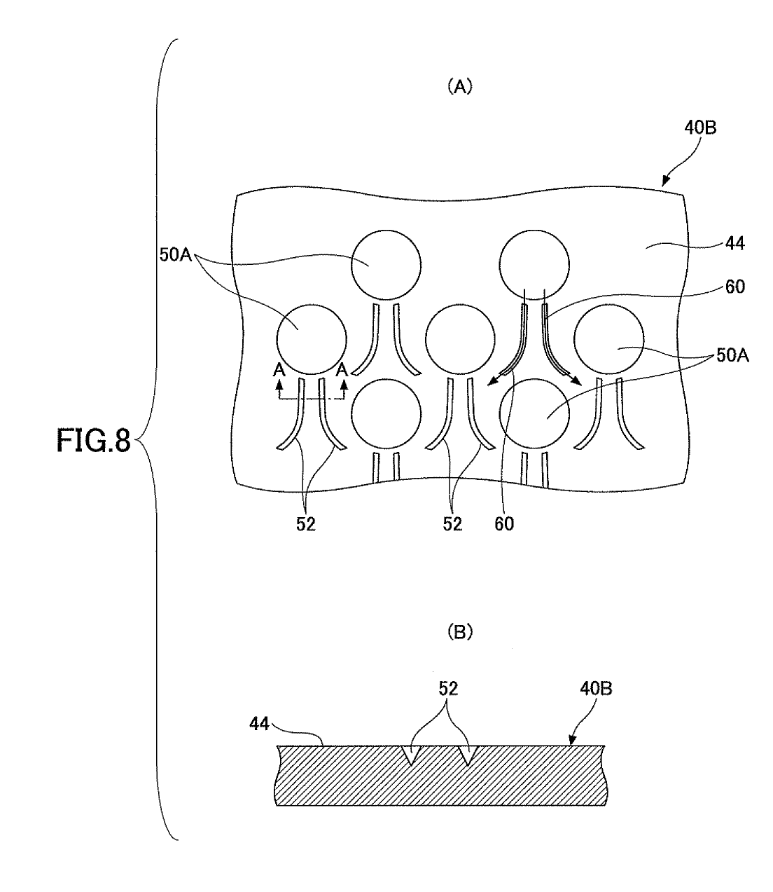

FIG. 8(A) through FIG. 10(B) are views for explaining oil separators of the second through fourth embodiments of the present invention. In FIG. 8(A) through FIG. 10(B), parts that are the same as the parts shown in FIG. 2 through FIG. 6 are given the same reference numerals, and explanation thereof is omitted. In addition, vicinities of forming positions of the piercing holes in the punching plate among elements forming the oil separator are shown in expanded manners in FIG. 8(A) through FIG. 10(B).

In the first embodiment of the present invention, as discussed above, by optimizing the diameter D of the piercing holes 50A, the pitch P of neighboring piercing holes 50A, and the ratio (R_{OP}) of the hole area of the piercing holes 50A at the surface 44 of the punching plate 40A, it is possible to form a structure where the leaking oil 60 flows on only the surface of the punching plate 40A as shown in FIG. 6 and does not flow into other piercing holes 50A. On the other hand, in the second through fourth embodiments, by providing a part configured to block flowing-in of the leaking oil 60 to other piercing holes 50A, the leaking oil 60 flows on only the surface 44 of the punching plate 40A and does not flow into other piercing holes 50A.

FIG. 8(A) shows a punching plate 40B of an oil separator of the second embodiment of the present invention. In the second embodiment of the present invention, grooves 52 are formed in a surface of the punching plate 40B.

A pair (two) of the grooves 52 is formed so as to extend downward from an underneath position of each of the piercing holes 50A and to have configurations curved in horizontal directions in the vicinity of another piercing hole 50A situated below the piercing hole 50A. Accordingly, when the pair of the grooves 52 is seen from a front side, the grooves 52 have a configuration opposite to a “V” shape with a gap at the top. FIG. 8(B) is a cross-section taken along a line A-A of FIG. 8(A). As shown in FIG. 8(B), the groove 52 has a triangular-shaped cross section.

By forming the grooves 52, the leaking oil 60 leaking from the piercing hole 50A is guided by the grooves 52 so as to flow. Because of this, even if the leaking oil 60 flows to the vicinity of other piercing holes 50A situated below the piercing hole 50A where the leaking oil 60 leaks out, the leaking oil 50A flows so as to avoid the piercing holes 50A situated below the piercing hole 50A where the leaking oil 60 leaks out, because the grooves 52 have a configuration opposite to a “V” shape with a gap at the top, namely a configuration separating from the piercing holes 50A situated below the piercing hole 50A where the leaking oil 60 leaks out. Therefore, the leaking oil does not flow into other piercing holes 50A and therefore bubbling is not generated. Hence, it is possible to prevent the leaking oil 60 from being mixed with the supply gas.

Although the number of the grooves 52 for each piercing hole 50A is two and the grooves 52 have a configuration opposite to a “V” shape with a gap at the top in the second embodiment show in FIG. 7, the present invention is not limited to this example. The number of the grooves 52 for each piercing hole 50A is not limited to two. The front view configuration and the cross-sectional configuration of the groove 52 may be other configurations as long as flowing-in of the leaking oil 60 to other piercing holes 50A can be blocked.

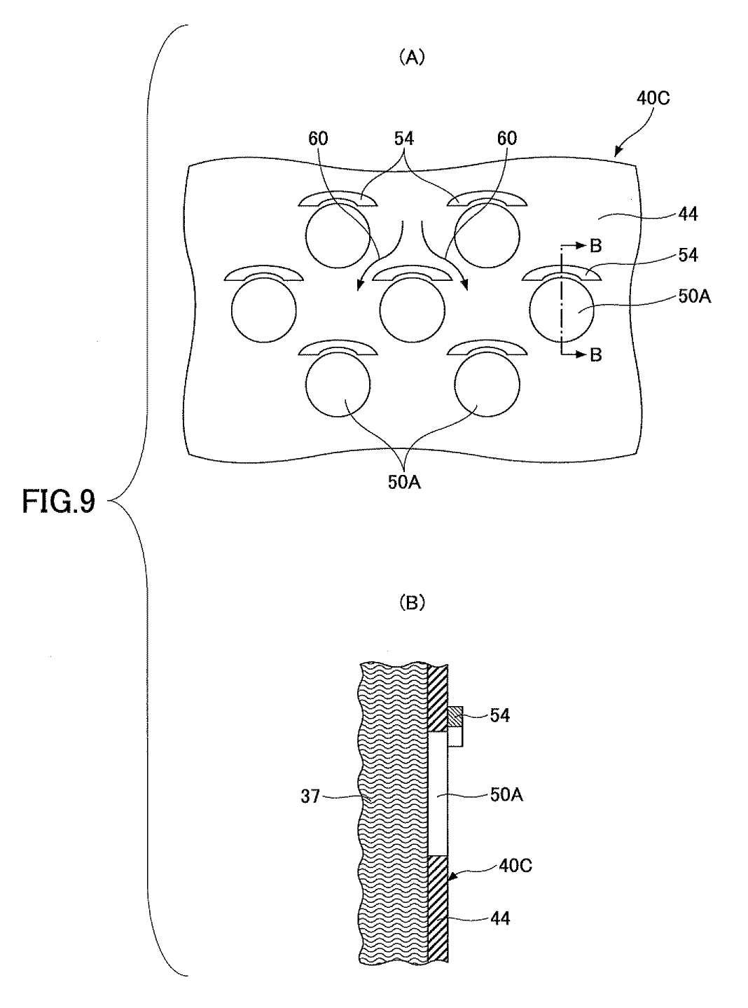

In the meantime, FIG. 9(A) shows a punching plate 40C of an oil separator of the third embodiment of the present invention. FIG. 9(B) is a cross-section taken along a line B-B of FIG. 9(A).

In the third embodiment of the present invention, brim parts (dam parts) 54 are formed above the piercing holes 50A in the surface 44 of the punching plate 40B. Each of the brim parts 54 projects from the surface 44 of the punching plate 40C as show in FIG. 9(A). In addition, each of the brim parts 54 is formed so as to cover an upper part of the corresponding piercing hole 50A.

Accordingly, even if the leaking oil 60 leaks out from the piercing hole 50A and flows to other piercing holes 50A situated underneath the piercing hole 50A, flowing-in of the leaking oil 60 to other piercing holes 50A is blocked by the brim parts 54. Therefore bubbling is not generated. Hence, it is possible to prevent the leaking oil 60 from being mixed with the supply gas.

Although the brim parts 54 are provided only above the piercing holes 50A in the example shown in FIG. 9(A), the brim parts 54 may be widely provided so as to surround the external circumferences of the piercing holes 50A. In addition, although the projection amount of the brim parts 54 from the surface 44 depends on the volume of the oil separator 15 and others, the height of the brim parts 54 should be determined based on the leaking amount of the leaking oil 60 expected to flow on the surface 44 of the punching plate 40 so that the leaking oil 60 does not get over the brim parts 54.

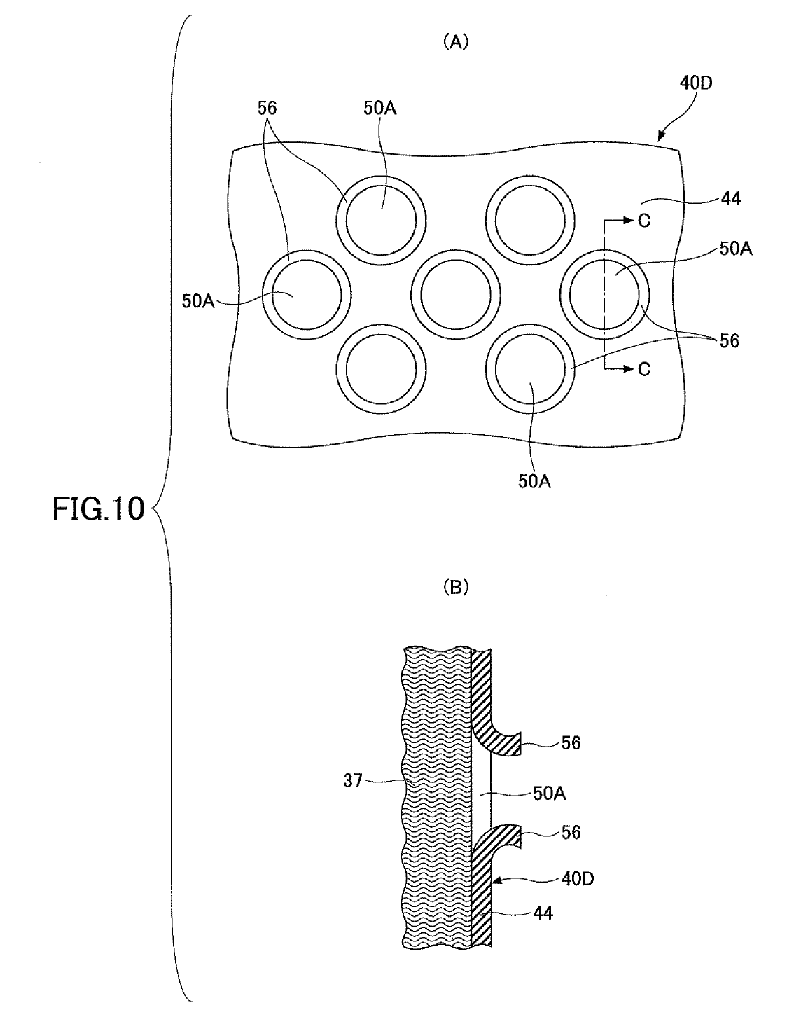

In the meantime, FIG. 10(A) shows a punching plate 40D of an oil separator of the fourth embodiment of the present invention. FIG. 10(B) is a cross-section taken along a line C-C of FIG. 10(A).

In the fourth embodiment of the present invention, a burring process is used as a method of forming the piercing holes 50A.

The burring process is a process method of forming a hole flange. In this process, a pilot hole is opened in a board (the punching plate 40A in this example) in advance and then a press process is applied by using a jig such as a punch so that a flange stands up. Thus, by forming the piercing hole 50A with the burring process, a ring-shaped projection part 56 is formed at the external circumferential part of the piercing hole 50A.

Accordingly, even if the leaking oil 60 leaks out from the piercing hole 50A so as to move to other piercing holes 50A under the piercing hole 50A where the leaking oil 60 leaks out, flowing-in of the leaking oil 60 to other piercing holes 50A is blocked by the projection parts 56. Therefore bubbling is not generated. Hence, it is possible to prevent the leaking oil 60 from being mixed with the supply gas. Furthermore, in this embodiment, since the projection parts 56 are formed in a lump simultaneously with forming of the piercing holes 50A, it is possible to easily form a part configured to prevent flowing-in of the leaking oil 60 to the piercing holes 50A.

Next, fifth and sixth embodiments of the present invention are discussed.

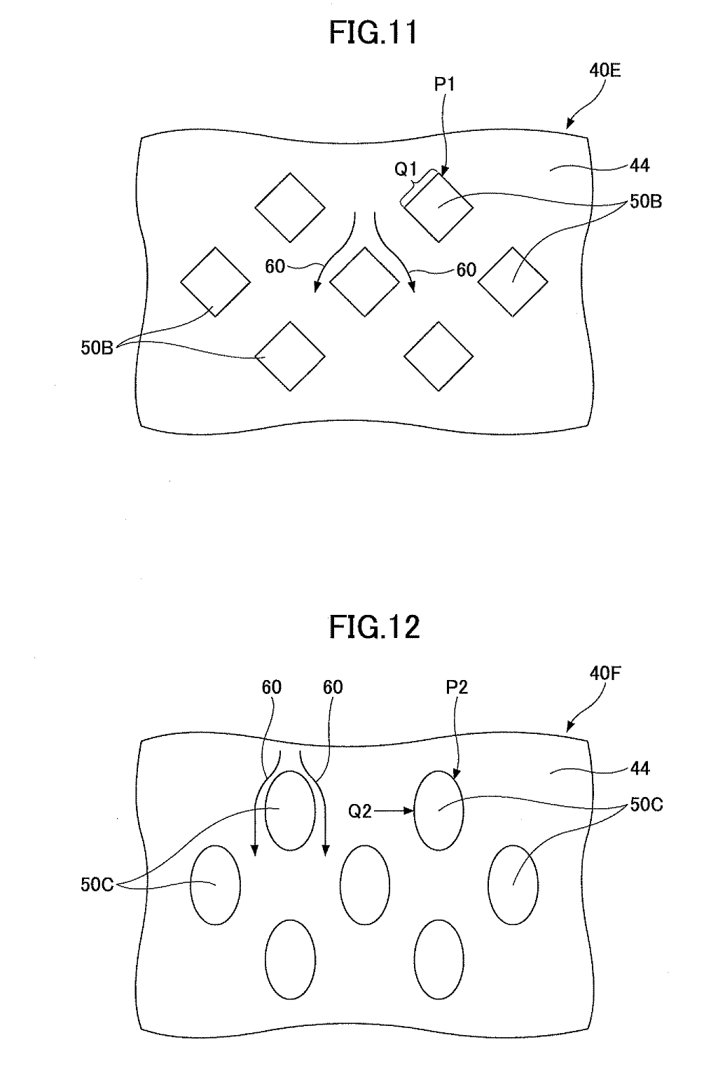

FIG. 11 and FIG. 12 are views for explaining oil separators of the fifth and sixth embodiments of the present invention. In FIG. 11 and FIG. 12, parts that are the same as the parts shown in FIG. 2 through FIG. 6 are given the same reference numerals, and explanation thereof is omitted. In addition, vicinities of forming positions of the piercing holes in the punching plates are shown in expanded manners in FIG. 11 and FIG. 12.

In the first embodiment of the present invention, as discussed above, by optimizing the diameter D of the piercing holes 50A and other parts, generation of bubbling is prevented and the leaking oil 60 is prevented from being mixed with the supply gas. In the second through fourth embodiments, by providing parts, such as the grooves 52, configured to block flowing-in of the leaking oil 60 to other piercing holes 50A, generation of bubbling is prevented and the leaking oil 60 is prevented from being mixed with the supply gas.

On the other hand, in the fifth and sixth embodiments of the present invention, by optimizing a configuration of piercing holes formed in the punching plate, the leaking oil 60 is prevented from being mixed with the supply gas.

In the fifth embodiment shown in FIG. 11, piercing holes 503 formed in a punching plate 40E have rectangular-shaped configurations. In the sixth embodiment shown in FIG. 12, piercing holes 50C formed in a punching plate 40F have elliptical-shaped configurations. In addition, the rectangular-shaped piercing holes 50B and the elliptical-shaped piercing holes 50C are formed in the punching plates 40E and 40F so that sharp parts of the piercing holes 50B and 50C (positions indicated by arrows P1 and P2 in FIG. 11 and FIG. 12) stand face to face in a direction where the leaking oil 60 flows.

Here, flow resistance R2 when the leaking oil 60 flows in the piercing holes from the surface 44 is greater than flow resistance R1 when the leaking oil 60 flows on the surface 44 (R2>R1) because the flow resistance R2 accompanies a change of flow and there is less change of the flow in the case of the flow resistance R1.

Hypothetically assuming a structure where side parts Q1 of the rectangular-shaped piercing holes 50B or apex parts Q2 at a major axis side of the elliptical-shaped piercing holes 50C stand face to face in the direction where the leaking oil 60 flows, even if flow resistance to the piercing holes 50B and 50C is greater than the flow resistance R1 on the surface 44, the leaking oil 60 flows in the piercing holes 50B and 50C because the piercing holes 50B and 50C widely stand face to face with the flow direction of the leaking oil 60.

On the other hand, in the fifth and sixth embodiments of the present invention, a boundary portion of the surface 44 and the piercing holes 50B, the boundary portion having flow resistance greater than one on the surface 44, tapers to a point (portions standing face to face with the leaking oil 60 are narrow). Accordingly, the leaking oil 60 flows along the external circumferential part of the piercing holes 50B or 50C (boundary portion of the surface 44 and the piercing holes 50B or 50C) and thereby the flow amount of the leaking oil 60 flowing in the piercing holes 50B or 50C can be reduced. Hence, in this embodiment, generation of bubbling is prevented and the leaking oil 60 is prevented from being mixed with the supply gas.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An oil separator, comprising:
a first cylindrical-shaped punching plate having a plurality of first piercing holes;
a second cylindrical-shaped punching plate having a plurality of second piercing holes, the second cylindrical-shaped punching plate being situated inside the first cylindrical-shaped punching plate;
a filter member received between the first cylindrical-shaped punching plate and the second cylindrical-shaped punching plate, the filter member being configured to eliminate oil contained in a coolant gas;
a filter element where the coolant gas moves from the second cylindrical-shaped punching plate to the first cylindrical-shaped punching plate; and
a part configured to control leaking oil leaking from the first piercing holes of the first cylindrical-shaped punching plate so that the leaking oil flows on a surface of the first cylindrical-shaped punching plate excluding positions of the first piercing holes.

2. The oil separator as claimed in claim 1,
wherein the part configured to control the leaking oil is formed by a structure where a diameter of the first piercing hole is equal to or greater than 4 mm and equal to or less than 10 mm; a pitch of neighboring first piercing holes is equal to or greater than 6 mm and equal to or less than 15 mm; and a ratio (R_{OP}) of a hole area of the first piercing holes at the surface of the first cylindrical-shaped punching plate to the area of the surface of the first cylindrical-shaped punching plate is equal to or greater than 40% and equal to or less than 63%.

3. The oil separator as claimed in claim 1,
wherein the part configured to control the leaking oil is a groove formed in the surface of the first cylindrical-shaped punching plate and configured to guide flow of the leaking oil so that the leaking oil is prevented from leaking from one of the first piercing holes to another of the first piercing holes.

4. The oil separator as claimed in claim 1,
wherein the part configured to control the leaking oil is a brim part formed on the surface of the first cylindrical-shaped punching plate and configured to block flowing-in of the leaking oil to the first piercing holes.

5. The oil separator as claimed in claim 1,
wherein the part configured to control the leaking oil is formed by a structure where the first piercing holes have a rectangular-shaped configuration or an elliptical-shaped configuration;
and sharp parts of the first piercing holes stand face to face in a direction where the leaking oil flows.

6. The oil separator as claimed in claim 1,
wherein the part configured to control the leaking oil is a projection formed by applying a burring process to the first piercing holes at the first cylindrical-shaped punching plate.

7. A compressor for a regenerative refrigerator, the compressor being configured to supply coolant gas to the regenerative refrigerator, the compressor comprising:
an oil separator including
a first cylindrical-shaped punching plate having a plurality of first piercing holes;
a second cylindrical-shaped punching plate having a plurality of second piercing holes, the second cylindrical-shaped punching plate being situated inside the first cylindrical-shaped punching plate;
a filter member received between the first cylindrical-shaped punching plate and the second cylindrical-shaped punching plate, the filter member being configured to eliminate oil contained in the coolant gas;
a filter element where the coolant gas moves from the second cylindrical-shaped punching plate to the first cylindrical-shaped punching plate; and
a part configured to control leaking oil leaking from the first piercing holes of the first cylindrical-shaped punching plate so that the leaking oil flows on a surface of the first cylindrical-shaped punching plate excluding positions of the first piercing holes.
